(19) United States
(12) Patent Application Publication
(10) Pub. No.: US 2026/0108953 A1
(43) Pub. Date: Apr. 23, 2026

(54) COATED CEMENTED CARBIDE AND TOOL

(71) Applicant: SUMITOMO ELECTRIC HARDMETAL CORP., Hyogo (JP)

(72) Inventors: Kento YAMADA, Hyogo (JP); Shuhei MISUMI, Hyogo (JP); Taisuke HIGASHI, Hyogo (JP); Yasuki KIDO, Hyogo (JP); Yuki TANAKA, Hyogo (JP)

(73) Assignee: SUMITOMO ELECTRIC HARDMETAL CORP., Hyogo (JP)

(21) Appl. No.: 19/168,545

(22) PCT Filed: Jun. 6, 2024
(86) PCT No.: PCT/JP2024/020709

§ 371 Date: Sep. 24, 2025

(51) Int. Cl. B23B 27/14

(52) U.S. Cl. CPC B23B 27/148; B23B 2228/105

(57) ABSTRACT

A coated cemented carbide includes: a substrate consisting of a cemented carbide; and a diamond layer disposed directly on at least a portion of the substrate, wherein the cemented carbide includes a tungsten carbide grain and cobalt, the substrate includes an outer region and an inner region, the outer region having a gradient composition in which a content ratio of the cobalt is increased from an interface between the substrate and the diamond layer toward an inner portion of the substrate, the inner region being located on the inner portion side of the substrate with respect to the outer region, the content ratio of the cobalt in the inner region is 2 mass % or more, and a percentage (T₂/T₁)×100 of a standard deviation T₂ μm of a thickness of the outer region with respect to an average thickness T₁ μm of the outer region is 30% or less.

### TECHNICAL FIELD

The present disclosure relates to a coated cemented carbide and a tool.

### BACKGROUND ART

Conventionally, a coated cemented carbide including a substrate consisting of a cemented carbide and a diamond layer disposed directly on at least a portion of the substrate has been used as a material of a cutting tool or the like (PTL 1 to PTL 3).

### CITATION LIST

### Patent Literature

PTL 1: Japanese Patent Laying-Open No. H03-094062
PTL 2: WO 2004/031437
PTL 3: Japanese Patent Laying-Open No. 2011-038150

### SUMMARY OF INVENTION

A coated cemented carbide of the present disclosure is a coated cemented carbide comprising: a substrate consisting of a cemented carbide; and a diamond layer disposed directly on at least a portion of the substrate, wherein
the cemented carbide includes a tungsten carbide grain and cobalt,
the substrate includes an outer region and an inner region, the outer region having a gradient composition in which a content ratio of the cobalt is increased from an interface between the substrate and the diamond layer toward an inner portion of the substrate, the inner region being located on the inner portion side of the substrate with respect to the outer region,
the content ratio of the cobalt in the inner region is 2 mass % or more, and
a percentage (T₂/T₁)×100 of a standard deviation T₂ μm of a thickness of the outer region with respect to an average thickness T₁ μm of the outer region is 30% or less.

### BRIEF DESCRIPTION OF DRAWINGS

FIG. 1 is a diagram schematically showing a cross section of a coated cemented carbide according to one embodiment of the present disclosure.

FIG. 2 is an enlarged view of a region II in FIG. 1.

FIG. 3 is a perspective view illustrating one implementation of a tool.

### DETAILED DESCRIPTION

### Problem to be Solved by the Present Disclosure

When a coated cemented carbide including a substrate consisting of a cemented carbide and a diamond layer disposed directly on at least a portion of the substrate is used as a material of a tool such as a cutting tool, resistance against detachment of the diamond layer from the substrate (that is, “detachment resistance”) may not be sufficient. Therefore, when such a coated cemented carbide is used for a tool such as a cutting tool, the life of the tool may not be sufficient.

Therefore, an object of the present disclosure is to provide: a coated cemented carbide having excellent detachment resistance; and a tool consisting of the coated cemented carbide.

### Advantageous Effect of the Present Disclosure

According to the present disclosure, it is possible to provide: a coated cemented carbide having excellent detachment resistance; and a tool consisting of the coated cemented carbide.

### DESCRIPTION OF EMBODIMENTS

First, embodiments of the present disclosure will be listed and described.
(1) A coated cemented carbide of the present disclosure is a coated cemented carbide comprising: a substrate consisting of a cemented carbide; and a diamond layer disposed directly on at least a portion of the substrate, wherein
the cemented carbide includes a tungsten carbide grain and cobalt,
the substrate includes an outer region and an inner region, the outer region having a gradient composition in which a content ratio of the cobalt is increased from an interface between the substrate and the diamond layer toward an inner portion of the substrate, the inner region being located on the inner portion side of the substrate with respect to the outer region,
the content ratio of the cobalt in the inner region is 2 mass % or more, and
a percentage (T₂/T₁)×100 of a standard deviation T₂ μm of a thickness of the outer region with respect to an average thickness T₁ μm of the outer region is 30% or less.

According to the present disclosure, a coated cemented carbide having excellent detachment resistance and a tool consisting of the coated cemented carbide can be provided.
(2) In (1), the average thickness T₁ of the outer region may be 1 μm or more and 5 μm or less. Thus, a coated cemented carbide having more excellent detachment resistance and a tool consisting of the coated cemented carbide can be provided.
(3) In (1) or (2), an average thickness of the diamond layer may be 3 μm or more and 28 μm or less. Thus, a coated cemented carbide having more excellent detachment resistance and a tool consisting of the coated cemented carbide can be provided.
(4) In any one of (1) to (3), in a cross section of the coated cemented carbide along a normal direction of a surface of the diamond layer, the substrate may be provided with a recess having a depth of 1 μm or more at the interface between the substrate and the diamond layer, and
an average of a width of the recess at a depth position of 1 μm of the recess may be 1 μm or more and 3 μm or less. Thus, a coated cemented carbide having more excellent detachment resistance and a tool consisting of the coated cemented carbide can be provided.
(5) In (4), the number of first recesses, each of which is the recess having the width of more than 10 μm at the depth position of 1 μm of the recess, may be 1 or less in a rectangular visual field provided in the cross section and including the interface between the substrate and the diamond layer, the rectangular visual field having a length of 80 μm along the normal direction of the surface of the diamond layer and a length of 110 μm in a direction along the surface of the diamond layer. Thus, a coated cemented carbide having more excellent detachment resistance and a tool consisting of the coated cemented carbide can be provided.
(6) In any one of (1) to (5), a content ratio of the tungsten carbide grain in the cemented carbide may be 90 mass % or more and 98 mass % or less. Thus, a coated cemented carbide having more excellent detachment resistance and a tool consisting of the coated cemented carbide can be provided.
(7) In any one of (1) to (6), the content ratio of the cobalt in the cemented carbide may be 2 mass % or more and 10 mass % or less. Thus, a coated cemented carbide having more excellent detachment resistance and a tool consisting of the coated cemented carbide can be provided.
(8) A tool of the present disclosure consists of the coated cemented carbide according to any one of (1) to (7).

According to the present disclosure, a tool consisting of a coated cemented carbide having excellent detachment resistance can be provided.

### DETAILS OF EMBODIMENTS OF THE PRESENT DISCLOSURE

Specific examples of the coated cemented carbide according to one embodiment (hereinafter, also referred to as “the present embodiment”) of the present disclosure will be described below with reference to figures. In the figures of the present disclosure, the same reference characters represent the same or corresponding portions. Further, a dimensional relation such as a length, a width, a thickness, or a depth is appropriately changed for clarity and simplification of the figures, and therefore do not necessarily represent an actual dimensional relation.

In the present disclosure, the expression “A to B” represents a range of lower to upper limits (i.e., A or more and B or less), and when no unit is indicated for A and a unit is indicated only for B, the unit of A is the same as the unit of B.

When a compound or the like is expressed by a chemical formula in the present disclosure and an atomic ratio is not particularly limited, it is assumed that all the conventionally known atomic ratios are included, and the atomic ratio should not be necessarily limited only to one in the stoichiometric range.

### First Embodiment: Coated Cemented Carbide

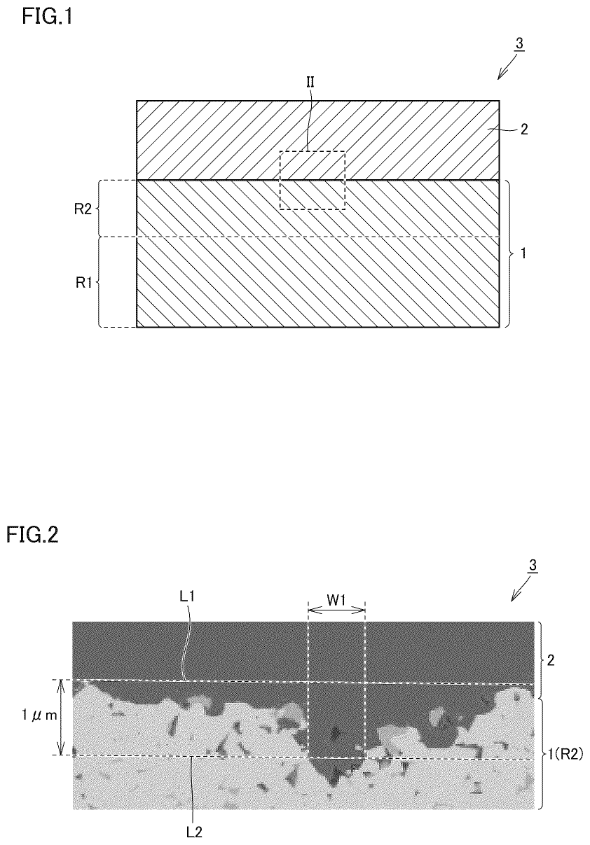

A coated cemented carbide according to one embodiment of the present disclosure will be described with reference to FIGS. 1 and 2. FIG. 1 is a diagram schematically showing a cross section of the coated cemented carbide according to one embodiment of the present disclosure. FIG. 2 is an enlarged view of a region II in FIG. 1.

One embodiment of the present disclosure (hereinafter, also referred to as “the present embodiment”) is directed to a coated cemented carbide 3 comprising: a substrate 1 consisting of a cemented carbide; and a diamond layer 2 disposed directly on at least a portion of substrate 1, wherein
the cemented carbide includes a tungsten carbide grain and cobalt,
substrate 1 includes an outer region R2 and an inner region R1, outer region R2 having a gradient composition in which a content ratio of cobalt is increased from an interface between substrate 1 and diamond layer 2 toward an inner portion of substrate 1, inner region R1 being located on the inner portion side of substrate 1 with respect to outer region R2,
the content ratio of the cobalt in inner region R1 is 2 mass % or more, and
a percentage (T₂/T₁)×100 of a standard deviation T₂ μm of a thickness of outer region R2 with respect to an average thickness T₁ μm of outer region R2 is 30% or less.

According to the present disclosure, coated cemented carbide 3 having excellent detachment resistance and a tool consisting of coated cemented carbide 3 can be provided. A reason therefor is presumed as follows.

In coated cemented carbide 3 of the present embodiment, substrate 1 includes outer region R2 and inner region R1, outer region R2 having the gradient composition in which the content ratio of the cobalt is increased from the interface between substrate 1 and diamond layer 2 toward the inner portion of substrate 1, inner region R1 being located on the inner portion side of substrate 1 with respect to outer region R2, the content ratio of the cobalt in inner region R1 is 2 mass % or more, and the percentage (T₂/T₁)×100 of the standard deviation T₂ μm of the thickness of outer region R2 with respect to the average thickness T₁ μm of outer region R2 is 30% or less. According to this, variation in the thickness of outer region R2 is suppressed to be sufficiently low and adhesion between substrate 1 and diamond layer 2 is therefore improved, thereby improving detachment resistance of coated cemented carbide 3.

### <<Substrate>>

Coated cemented carbide 3 includes substrate 1 consisting of the cemented carbide. The cemented carbide includes tungsten carbide grains and cobalt. The cemented carbide may further include nickel. The cemented carbide may further include another component as long as the effects of the present disclosure are not impaired. Examples of the other component include: a carbide, nitride, or carbonitride each including at least one element selected from a group consisting of titanium (Ti), tantalum (Ta), niobium (Nb), zirconium (Zr), hafnium (Hf), and molybdenum (Mo); an inevitable impurity; and the like. Examples of the inevitable impurity include iron (Fe), calcium (Ca), oxygen (O), sulfur(S), and the like.

The content ratio of the tungsten carbide grains in the cemented carbide may be 90 mass % or more and 98 mass % or less. Thus, the area of a contact interface between the tungsten carbide grain and a below-described diamond grain in diamond layer 2, which have high adhesion, can be sufficiently secured, with the result that the detachment resistance of coated cemented carbide 3 can be further improved. The content ratio of the tungsten carbide grains in the cemented carbide may be 91 mass % or more and 97 mass % or less, or 92 mass % or more and 96 mass % or less. It should be noted that the tungsten carbide grains include at least either of “pure WC grains (WC containing no impurity element at all and WC in which the content of an impurity element is less than the detection limit are also included)” and “WC grains in each of which an impurity element is intentionally or inevitably contained as long as the effects of the present disclosure are not impaired”. The content ratio of the impurity in the tungsten carbide grains (when the impurity is constituted of two or more types of elements, the total content ratio of the two or more types of elements) is less than 0.1 mass % The content ratio of the impurity element in the tungsten carbide grains is measured by the ICP emission spectroscopy (Inductively Coupled Plasma Emission Spectroscopy, measurement apparatus: “ICPS-8100” (trademark) provided by Shimadzu Corporation).

The content ratio of the cobalt in the cemented carbide may be 2 mass % or more and 10 mass % or less. Thus, since generation of graphite due to the presence of the cobalt is suppressed, the detachment resistance of coated cemented carbide 3 can be further improved. The content ratio of the cobalt in the cemented carbide may be 3 mass % or more and 9 mass % or less, or 4 mass % or more and 8 mass % or less.

The composition of substrate 1 can be specified by specifying the content ratio of each component in inner region R1 by ICP emission spectroscopy (Inductively Coupled Plasma Emission Spectroscopy (measurement apparatus: “ICPS-8100” (trademark) provided by Shimadzu Corporation) and calculating the average value (arithmetic average) of the content ratio of each component in inner region R1.

In the first embodiment, the average grain size of the tungsten carbide grains is not particularly limited. The average grain size of the tungsten carbide grains can be, for example, 0.5 μm or more and 3 μm or less. It has been confirmed that coated cemented carbide 3 of the first embodiment can have excellent detachment resistance regardless of the average grain size of the tungsten carbide grains.

The average grain size of the tungsten carbide grains can be specified by the following procedures (A1) to (H1).
(A1) Coated cemented carbide 3 is cut out at any position to expose a cross section. The cross section is mirror-finished with a cross section polisher (provided by JEOL).
(B1) An analysis is performed onto a region of substrate 1 at the mirror-finished surface of coated cemented carbide 3 by using a scanning electron microscope-energy dispersive X-ray spectroscopy (SEM-EDX) (apparatus: Gemini 450 (trademark) provided by Carl Zeiss) so as to specify elements included in substrate 1.
(C1) The region of substrate 1 at the mirror-finished surface of coated cemented carbide 3 is imaged using a scanning electron microscope (SEM) so as to obtain a reflected electron image. The imaging region of the captured image is set to a position (position at which the entire imaging region is a bulk portion of substrate 1) that does not include the central portion of the region of substrate 1 in the cross section of coated cemented carbide 3, i.e., a portion that is clearly different in property from the bulk portion, such as the vicinity of the interface between diamond layer 2 and substrate 1. An observation magnification is 5000 times. Measurement conditions are an acceleration voltage of 3 kV, a current value of 2 nA, and a working distance (WD) of 5 mm.
(D1) An analysis is performed onto the imaging region described above in (C1) using the energy dispersive X-ray spectrometer (SEM-EDX) accompanied with the SEM, the distribution of the elements specified as described above in (B1) is specified in the imaging region, thereby obtaining an element mapping image.
(E1) The reflected electron image obtained as described above in (C1) is loaded into a computer, and is subjected to binarization processing using image analysis software (OpenCV, SciPy). The binarization processing is performed such that only the tungsten carbide grains are extracted from the tungsten carbide grains and the binder phase in the reflected electron image. Since a threshold value for the binarization is changed depending on a contrast, the threshold value is set for each image.
(F1) The element mapping image obtained as described above in (D1) and the image having been through the binarization processing and obtained as described above in (E1) are superimposed on each other so as to specify respective regions in which tungsten carbide grains are present on the image having been through the binarization processing. Specifically, a region, which is shown in white in the image having been through the binarization processing and in which tungsten (W) and carbon (C) are present in the element mapping image, corresponds to the region in which the tungsten carbide grains are present.
(G1) One measurement visual field having a rectangular shape of 12.0 μm×8.2 μm is set in the image having been through the binarization processing. The outer edge of each tungsten carbide grain in the measurement visual field is specified using the image analysis software, and the equivalent circle diameter (Heywood diameter: equivalent-area equivalent circle diameter) of each tungsten carbide grain is calculated.
(H1) The D50 of the equivalent-area equivalent circle diameters of the tungsten carbide grains is calculated based on all the tungsten carbide grains in the measurement visual field.

As long as the measurement is performed for the same coated cemented carbide 3 by the above-described method, it is confirmed that there is no variation in measurement result even when a measurement location is freely changed.

### <Inner Region and Outer Region>

Substrate 1 includes outer region R2 and inner region R1, outer region R2 having the gradient composition in which the content ratio of the cobalt is increased from the interface between substrate 1 and diamond layer 2 toward the inner portion of substrate 1, inner region R1 being located on the inner portion side of substrate 1 with respect to outer region R2. The content ratio of the cobalt in inner region R1 is 2 mass % or more. Substrate 1 may consist of outer region R2 and inner region R1.

The percentage (T₂/T₁)×100 of the standard deviation T₂ μm of the thickness of outer region R2 with respect to the average thickness T₁ μm of outer region R2 is 30% or less. Thus, the detachment resistance of coated cemented carbide 3 can be improved. The percentage (T₂/T₁)×100 may be 1% or more and 30% or less, 3% or more and 25% or less, or 5% or more and 20% or less.

The average thickness T₁ of outer region R2 may be 1 μm or more and 5 μm or less. Thus, the detachment resistance of coated cemented carbide 3 can be further improved. The average thickness T₁ of outer region R2 may be 1.5 μm or more and 4.5 μm or less, or the average thickness T₁ of outer region R2 may be 2 μm or more and 4 μm or less.

The standard deviation T₂ μm of the thickness of outer region R2 may be 0.2 μm or more and 1.5 μm or less. Thus, the detachment resistance of coated cemented carbide 3 can be further improved. The standard deviation T₂ μm of the thickness of outer region R2 may be 0.25 μm or more and 1.25 μm or less, or may be 0.3 μm or more and 1.0 μm or less.

The average thickness T₁ μm of outer region R2 and the standard deviation T₂ μm of the thickness of outer region R2 can be specified by the following procedures (A2) to (E2).
(A2) A cross section is obtained by cutting coated cemented carbide 3 along a plane perpendicular to the surface of diamond layer 2, and the cross section is polished.
(B2) Two-visual-field imaging is performed using an electron microscope in a rectangular visual field of 25 μm in length×40 μm in width so as to include diamond layer 2 and substrate 1.
(C2) An EDX (energy dispersive X-ray spectroscopy) line analysis is performed. The line analysis is performed with a width of about 8 μm in a direction from the central point of the thickness of diamond layer 2 to a location of substrate 1 from which the binder phase has not been removed. The direction of the line analysis is perpendicular to the interface between diamond layer 2 and substrate 1. The line analysis is performed from the central point and beyond the outer region in which a void is generated, and is terminated at the inner region in which generation of void is not recognized. The measurement is performed at any five locations within one visual field.
(D2) Concentration profile numerical data of tungsten atoms (W) and cobalt atoms (Co) are obtained by the EDX line analysis in the form of csv or the like.
(E2) Fitting is performed for the concentration profile. First, the fitting is performed with “y=const.” for a region in which the concentrations of W and Co are constant (step 1). It is assumed that W:F (x)=a and Co:G(x)=b. Here, by confirming that the concentration of the Co in the fitting is 2 mass %, it is specified that the content ratio of the cobalt in the inner region is 2 mass % or more. Next, the fitting is performed with a linear function “y=ax+b” for a region in which the concentration gradients of the W and the Co are present (step II). The region for which the fitting is performed is a region having a certain range (for example, 50%±20% or 50%±30%) with 50% of the constant value obtained by the fitting in step I being centered. It is assumed that W:H (x)=cx+d and Co:I(x)=ex+f. Next, the thickness of outer region R2 is calculated (step III). A difference between the solution of H(x)=0 (the x coordinate at which the W concentration starts to rise) and the solution of G(x)=I(x) (the x coordinate at which the Co concentration starts to be decreased) is defined as the thickness of outer region R2. The average thickness T₁ and the standard deviation T₂ are specified by obtaining data at any ten locations and calculating the average values and standard deviation of the thicknesses thereat.

As long as the measurement is performed for the same coated cemented carbide 3 by the above-described method, it has been confirmed that there is no variation in measurement result even when the measurement location is freely changed or the range of the region for the fitting is freely changed within the above-described range in the above-described step II.

### <Recess of Substrate>

In the cross section of coated cemented carbide 3 along the normal direction of the surface of diamond layer 2, substrate 1 may be provided with the recess having the depth of 1 μm or more at the interface between substrate 1 and diamond layer 2, and the average of the width of the recess at the depth position of 1 μm of the recess may be 1 μm or more and 3 μm or less. Thus, generation of a starting point of local crack is suppressed and an anchor effect due to a moderate degree of unevenness is exhibited, with the result that the detachment resistance of coated cemented carbide 3 can be further improved. The average of the width of the recess at the depth position of 1 μm of the recess may be 1.5 μm or more and 2.5 μm or less.

The average of the width of the recess at the depth position of 1 μm of the recess can be specified by the following procedures (A3) to (D3).
(A3) A cross section is obtained by cutting coated cemented carbide 3 along a plane perpendicular to the surface of diamond layer 2, and the cross section is polished.
(B3) Two-visual-field imaging is performed by using an electron microscope in a visual field of 80 μm in length×110 μm in width so as to include diamond layer 2 and substrate 1. The surface of diamond layer 2 is imaged so as to be parallel to the end of the image (FIG. 2).
(C3) Two points of a WC grain closest to the surface of diamond layer 2 in the visual field are connected by a straight line L1, and a parallel line L2 at a distance of 1 μm from this straight line L1 is drawn on the substrate 1 side (FIG. 2).
(D3) A region of diamond layer 2 located on the substrate 1 side beyond parallel line L2 is specified, the number of such regions and the length of a line segment on parallel line L2 in each region (in other words, width W1 of the recess at the depth position of 1 μm of the recess) are measured, and the average value of the lengths of the line segments in the total of the two visual fields is calculated, thereby finding the average of the width of the recess (FIG. 2).

As long as the measurement is performed for the same coated cemented carbide 3 by the above-described method, it is confirmed that there is no variation in measurement result even when a measurement location is freely changed.

The number of first recesses, each of which is the recess having the width of more than 10 μm at the depth position of 1 μm of the recess, may be 1 or less in a rectangular visual field provided in the cross section and including the interface between substrate 1 and diamond layer 2, the rectangular visual field having a length of 80 μm along the normal direction of the surface of diamond layer 2 and a length of 110 μm in a direction along the surface of diamond layer 2. Thus, the contact area between substrate 1 and diamond layer 2 can be secured and the anchor effect between substrate 1 and diamond layer 2 can be ensured, with the result that the detachment resistance of coated cemented carbide 3 can be further improved. The number of the first recesses may be 0 or more and I or less, may be 0 or more and 0.8 or less, or may be 0 or more and 0.6 or less.

The number of the first recesses can be specified by the following procedures (A4) to (B4).
(A4) The above (A3) to (C3) are performed.
(B4) A region of diamond layer 2 located on the substrate 1 side beyond the parallel line is specified, and the number of the first recesses in each of which the length of the line segment on the parallel line in the region (in other words, the width of the recess at the depth position of 1 μm of the recess) is more than 10 μm is counted. By calculating the average value (arithmetic average) in the two visual fields, the number of the first recesses is specified.

As long as the measurement is performed for the same coated cemented carbide 3 by the above-described method, it is confirmed that there is no variation in measurement result even when a measurement location is freely changed.

### <<Diamond Layer>>

### <Composition of Diamond Layer>

Coated cemented carbide 3 includes diamond layer 2 disposed directly on at least a portion of substrate 1. Here, the expression “directly on” is not limited to the front surface side of coated cemented carbide 3 (i.e., the upper surface side of substrate 1) at the time of use, and represents a concept also including the rear surface side of coated cemented carbide 3 (i.e., the lower surface side of substrate 1) at the time of use. Diamond layer 2 means a layer that contains diamond. The diamond may be polycrystalline diamond. Here, the polycrystalline diamond means diamond in which diamond fine grains of about ten several nm to several μm are firmly coupled together. Diamond layer 2 may contain, as a component other than diamond, graphite, amorphous carbon, silicon atoms (Si), an inevitable impurity (for example, copper atoms (Cu), iron atoms (Fe), nickel atoms (Ni)), and the like, as long as the effects of the present disclosure are not impaired. It should be noted that the fact that diamond layer 2 contains the component other than the diamond can be specified by X-ray diffraction (XRD), Raman spectroscopy, secondary ion mass spectrometry (SIMS), or the like.

Coated cemented carbide 3 includes diamond layer 2 disposed directly on at least a portion of substrate 1. The average thickness of diamond layer 2 may be 3 μm or more and 28 μm or less. Thus, local stress concentration under application of load to diamond layer 2 can be reduced, with the result that the detachment resistance of coated cemented carbide 3 can be further improved. The average thickness of diamond layer 2 may be 4 μm or more and 27 μm or less, or 5 μm or more and 26 μm or less. The average thickness of diamond layer 2 can be adjusted by appropriately changing a film formation time in the diamond layer formation step.

The average thickness of diamond layer 2 can be found, for example, by performing measurement at any five locations in a cross sectional sample parallel to the normal direction of the surface of diamond layer 2 using a scanning electron microscope (Scanning Electron Microscope: SEM) and by determining the average value of the measured thicknesses at the five locations. For example, in order to produce the cross sectional sample, a focused ion beam apparatus, a cross section polisher apparatus, or the like can be used.

### <<Purpose of Use of Coated Cemented Carbide>>

Coated cemented carbide 3 of the present embodiment can be used for a tool (a cutting tool, a saw blade, an abrasion-resistant component, or the like), a mold, and the like. Examples of the cutting tool include a cutting tool for general-purpose processing. More specifically, examples of the cutting tool include cutting tools such as a drill, an end mill, a bite, an indexable insert, an indexable cutting insert for drill, an indexable cutting insert for end mill, an indexable cutting insert for milling, an indexable cutting insert for turning, a metal saw, a gear cutting tool, a reamer, a tap, and the like.

### Second Embodiment Method of Producing Coated Cemented Carbide

The coated cemented carbide according to the present embodiment includes the following steps in the following order: a step (hereinafter, also referred to as “substrate intermediate preparation step”) of preparing a substrate intermediate consisting of a cemented carbide; a step (hereinafter, also referred to as “surface treatment step”) of obtaining a substrate by performing surface treatment onto a surface of the substrate intermediate; and a step (hereinafter, also referred to as “diamond layer formation step”) of obtaining the coated cemented carbide by forming a diamond layer on the substrate by a chemical vapor deposition method.

### <<Preparation Step>>

In the preparation step, the substrate intermediate consisting of the cemented carbide is prepared. The substrate intermediate consisting of the cemented carbide may be prepared by producing it using a conventionally known method, or may be prepared by purchasing a commercially available product.

### <<Surface Treatment Step>>

In the surface treatment step, the substrate is obtained by performing the surface treatment onto the surface of the substrate intermediate consisting of the cemented carbide. As the surface treatment, etching treatment is performed. As the surface treatment, “sandblasting treatment” of spraying grains of alumina or silicon carbide, “lapping treatment” of reducing the surface roughness of the substrate intermediate, or both may be further performed prior to the etching treatment.

In the sandblasting treatment, the grain size of each of the grains may be, for example, 5 μm or more and 40 μm or less. Thus, the “number of the first recesses” as described in the first embodiment can be adjusted to fall within a desired range. In the sandblasting treatment, a spraying pressure may be 0.1 MPa or more and 0.4 MPa or less.

Specific examples of the lapping treatment include mechanical polishing and ion milling. Examples of the mechanical polishing include “AERO LAP (registered trademark)—mirror processing apparatus” A time of the lapping treatment may be, for example, 1 minute or more and 4 minutes or less. Thus, the “average of the width of the recess” as described in the first embodiment can be adjusted to fall within a desired range.

The etching treatment is performed by immersing the substrate intermediate in a mixed acid of sulfuric acid and nitric acid so as to dissolve a portion of the surface of the substrate intermediate. The etching treatment is performed while stirring the mixed acid. Thus, the content ratio of the cobalt in the outer region can be adjusted to fall within a desired range, and just below the diamond layer, the percentage (T₂/T₁)×100 of the standard deviation T₂ μm of the thickness of the outer region with respect to the average thickness T₁ μm of the outer region can be adjusted to fall within a desired range. In the mixed acid, the concentration of the sulfuric acid may be 10 mass % or more and 98 mass % or less, and the concentration of the nitric acid may be 10 mass % or more and 70 mass % or less. A time for immersing the substrate intermediate in the mixed acid (in other words, treatment time of the etching treatment) may be 0.5 minute or more and 60 minutes or less. The average thickness T₁ μm of the outer region can be adjusted to fall within a desired range by adjusting the time for immersing the substrate intermediate in the mixed acid to fall within the above range. A stirring speed may be 100 rpm or more and 300 rpm or less.

### <<Diamond Layer Formation Step>>

In the diamond layer formation step, the diamond layer is formed on the substrate by the chemical vapor deposition method, thereby obtaining the coated cemented carbide. Specifically, first, seeding treatment is performed by applying a diamond seed crystal onto the surface of the substrate. In doing so, the diamond seed crystal is dispersed in water at a concentration of 0.01 g/L or more, and the substrate is immersed in this diamond seed crystal aqueous solution.

The average grain size of the diamond seed crystal is preferably 0.005 μm or more and 0.5 μm or less. According to this, the nucleation density of the diamond becomes suitable to decrease the average void area ratio of the diamond layer, with the result that the detachment resistance of the diamond layer is improved. Here, the “average grain size” means a median diameter (d50) in a volume-based grain size distribution (volume distribution). The grain size of each crystal grain for calculating the average grain size of the diamond seed crystal is measured by a field emission scanning electron microscope (FE-SEM).

Next, the diamond layer is formed by the CVD method on the surface of the substrate on the side on which the diamond seed crystal is seeded, thereby obtaining the coated cemented carbide. As the CVD method, a conventionally known CVD method can be used. For example, a microwave plasma CVD method, a plasma jet CVD method, a thermal filament CVD method, or the like can be used.

For example, the diamond layer can be formed on the substrate in the following manner, the substrate is placed in a thermal filament CVD apparatus, methane gas and hydrogen gas are introduced into the apparatus at a mixing ratio of 0.5:99.5 to 10:90 on a volume basis, and the substrate temperature is maintained at 700° C. or more and 900° C. or less.

### Third Embodiment: Tool

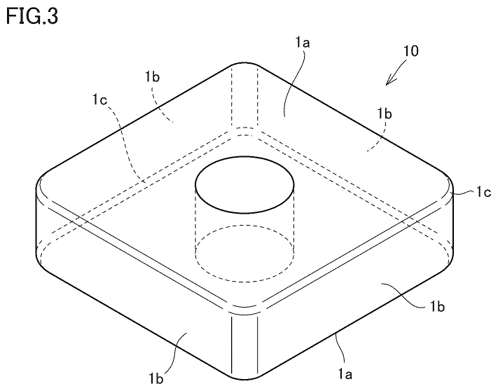

A tool according to one embodiment of the present disclosure will be described with reference to FIG. 3. FIG. 3 is a perspective view illustrating one implementation of a tool.

A tool 10 according to the present embodiment consists of the coated cemented carbide according to the first embodiment.

According to the present disclosure, a tool consisting of a coated cemented carbide having excellent detachment resistance can be provided. A reason therefor is as described in the first embodiment.

Examples of tool 10 according to the present disclosure include a cutting tool having a shape shown in FIG. 3.

### <<Method of Producing Tool>>

A method of producing tool 10 according to the present disclosure can be performed by the same method as a conventionally known method except that the coated cemented carbide described in the first embodiment is used.

### EXAMPLES

The present embodiment will be described more specifically with reference to examples. However, the present embodiment is not limited by these examples.

### <<Production of Coated Cemented Carbide>>

Each of coated cemented carbides according to samples 1 to 20 and 101 was produced by performing the following steps in the following order.

### <Preparation Step>

As a substrate intermediate consisting of a cemented carbide, a cutting insert for turning was prepared which was composed of WC-Co (cemented carbide) and had a shape of tool model number SNGN120408. The content ratio of the WC and the content ratio of the Co in the WC-Co were adjusted to become content ratios [mass %] described in Table 3.

### <Surface Treatment Step>

Surface treatment was performed onto the surface of the cutting insert for turning (substrate intermediate) under conditions shown in Table 1, thereby obtaining a substrate. It should be noted that sandblasting treatment, lapping treatment, and etching treatment were performed in this order. When 0 rpm is described in the column “Stirring Speed [rpm]” of the column “Etching Treatment” of Table 1, it means that stirring was not performed in the etching treatment. When the stirring was performed in the etching treatment, the stirring was performed by using a magnetic stirrer. In the etching treatment, a mixed acid of sulfuric acid and nitric acid at a mixture ratio of 1:3 on a volume basis was used. When the lapping treatment was performed, conditions for the lapping treatment were such that the surface of the substrate intermediate was polished for a time described in Table 1 by using a dry shot type mirror polishing machine.

### <Diamond Layer Formation Step>

First, the surface of the substrate was seeded with a diamond seed crystal. Next, a diamond layer was formed on the substrate by the chemical vapor deposition method under conditions shown in Table 2 until the average thickness of the diamond layer became as shown in Table 3. A methane gas concentration with respect to hydrogen gas was 1 volume %.

The coated cemented carbides according to samples 1 to 20 and 101 were produced by the above procedure.

TABLE 1

| | Surface Treatment Step | | | | |
|---|---|---|---|---|---|
| | Sandblasting | | | Etching Treatment | |
| | Treatment | Lapping Treatment | | Treatment | Stirring |
| Sample | Grain Size | Performed or | Time | Time | Speed |
| No. | [μm] | Not Performed | [min] | [min] | [rpm] |
| 1 | 20 | Performed | 2 | 20 | 300 |
| 2 | 20 | Performed | 2 | 20 | 100 |
| 3 | 20 | Performed | 2 | 7 | 300 |
| 4 | 20 | Performed | 2 | 35 | 300 |
| 5 | 20 | Performed | 2 | 4 | 300 |
| 6 | 20 | Performed | 2 | 40 | 300 |
| 7 | 20 | Performed | 2 | 20 | 300 |
| 8 | 20 | Performed | 2 | 20 | 300 |
| 9 | 20 | Performed | 2 | 20 | 300 |
| 10 | 20 | Performed | 2 | 20 | 300 |
| 11 | 20 | Performed | 4 | 20 | 300 |
| 12 | 20 | Performed | 1 | 20 | 300 |
| 13 | 20 | Performed | 20 | 20 | 300 |
| 14 | 20 | Not Performed | — | 20 | 300 |
| 15 | 40 | Performed | 2 | 20 | 300 |
| 16 | 80 | Performed | 2 | 20 | 300 |
| 17 | 20 | Performed | 2 | 20 | 300 |
| 18 | 20 | Performed | 2 | 20 | 300 |
| 19 | 20 | Performed | 2 | 20 | 300 |
| 20 | 20 | Performed | 2 | 20 | 300 |
| 101 | 20 | Performed | 1 | 20 | 0 |

TABLE 2

| | Diamond Layer Formation Step |
|---|---|
| Sample | Film Formation Time |
| No. | [h] |
| 1 | 47 |
| 2 | 47 |
| 3 | 47 |
| 4 | 47 |
| 5 | 47 |
| 6 | 47 |
| 7 | 7 |
| 8 | 65 |
| 9 | 6 |
| 10 | 71 |
| 11 | 47 |
| 12 | 47 |
| 13 | 47 |
| 14 | 47 |
| 15 | 47 |
| 16 | 47 |
| 17 | 47 |
| 18 | 47 |
| 19 | 47 |
| 20 | 47 |
| 101 | 47 |

TABLE 3

| | Substrate | | | | | | | | |
|---|---|---|---|---|---|---|---|---|---|
| | WC | | Outer Region | | | | | | |
| | Grain | Co | Average | Standard | | Average of | | Diamond Layer | Cutting Test |
| | Content | Content | Thickness | Deviation | | Width of | Number of | Average | Processing |
| Sample | Ratio | Ratio | T₁ | T₂ | (T₂/T₁) × | Recess | First | Thickness | Area |
| No. | [mass %] | [mass %] | [μm] | [μm] | 100 [%] | [μm] | Recesses | [μm] | [mm²] |
| 1 | 94 | 5 | 3.8 | 0.7 | 19 | 1.5 | 0 | 19.7 | 2016 |
| 2 | 94 | 5 | 3.5 | 1.1 | 30 | 1.8 | 0 | 20 | 2049 |
| 3 | 94 | 5 | 1 | 0.2 | 18 | 1.7 | 0 | 20.3 | 1982 |
| 4 | 94 | 5 | 5 | 1.0 | 20 | 1.8 | 0 | 20.6 | 2016 |
| 5 | 94 | 5 | 0.4 | 0.1 | 25 | 2 | 0 | 20.6 | 1411 |
| 6 | 94 | 5 | 6 | 1.1 | 19 | 1.2 | 0 | 20.4 | 1411 |
| 7 | 94 | 5 | 3.3 | 0.8 | 24 | 2 | 0 | 3 | 1915 |
| 8 | 94 | 5 | 3.1 | 0.6 | 20 | 1.4 | 0 | 28 | 2016 |
| 9 | 94 | 5 | 2 | 0.4 | 20 | 2.2 | 0 | 2.3 | 1445 |
| 10 | 94 | 5 | 2.7 | 0.6 | 23 | 1.9 | 0 | 30 | 1478 |
| 11 | 94 | 5 | 3.6 | 0.7 | 20 | 1 | 0 | 20 | 1982 |
| 12 | 94 | 5 | 2.6 | 0.4 | 15 | 3 | 0 | 20.3 | 1915 |
| 13 | 94 | 5 | 2.6 | 0.5 | 18 | 0.4 | 0 | 19.8 | 1579 |
| 14 | 94 | 5 | 3 | 0.6 | 19 | 4.1 | 0 | 20.1 | 1546 |
| 15 | 94 | 5 | 2.9 | 0.5 | 18 | 2.1 | 1 | 20.5 | 1949 |
| 16 | 94 | 5 | 3.1 | 0.7 | 22 | 1.6 | 3 | 20 | 1680 |
| 17 | 90 | 10 | 3.3 | 0.7 | 22 | 2 | 0 | 19.9 | 2016 |
| 18 | 98 | 2 | 3 | 0.6 | 19 | 1.3 | 0 | 20.2 | 1949 |
| 19 | 87 | 12 | 3 | 0.6 | 20 | 1.5 | 0 | 20.1 | 1747 |
| 20 | 99 | 0.8 | 3 | 0.6 | 19 | 1.5 | 0 | 20.4 | 1781 |
| 101 | 94 | 5 | 3.1 | 1.1 | 36 | 4.42 | 0 | 20 | 1344 |

### <<Evaluation on Properties of Coated Cemented Carbide>>>

5<Average Thickness T₁ of Outer Region and Standard Deviation T₂ of Thickness of Outer Region>

For the coated cemented carbide according to each sample, the average thickness T₁ of the outer region was determined by the method described in the first embodiment. The obtained results are shown in the column “Average Thickness T₁ [μm]” of the column “Outer Region” of Table 3. Further, for the coated cemented carbide according to each sample, the standard deviation T₂ of the thickness of the outer region was determined by the method described in the first embodiment. The obtained results are shown in the column “Standard Deviation T₂ [μm]” of the column “Outer Region” of Table 3.

### <Average of Width of Recess>

For the coated cemented carbide according to each sample, the average of the width of the recess at the depth position of 1 μm of the recess was determined by the method described in the first embodiment. The obtained results are shown in the column “Average of Width [μm] of Recess” in Table 3.

### <Number of First Recesses>

For the coated cemented carbide according to each sample, the number of first recesses, each of which is the recess having the width of more than 10 μm at the depth position of 1 μm of the recess, was determined by the method described in the first embodiment. The obtained results are shown in the column “Number of First Recesses” of Table 3.

### <Content Ratio of Tungsten Carbide Grains and Content Ratio of Cobalt>

For the coated cemented carbide according to each sample, the content ratio of the tungsten carbide grains in the cemented carbide was determined by the method described in the first embodiment. The obtained results are shown in the column “WC Grain Content Ratio [mass %]” in Table 3. For the coated cemented carbide according to each sample, the content ratio of the cobalt in the cemented carbide was determined by the method described in the first embodiment. The obtained results are shown in the column “Co Content Ratio [mass %]” in Table 3.

### <<Cutting Test>>

The coated cemented carbide according to each sample was used as a cutting tool so as to perform milling onto the upper surface of the following workpiece under the following conditions. The milling was performed until occurrence of detachment of the diamond layer in the cutting tool, and a processing area until the occurrence of detachment was specified. The obtained results are shown in the column “Processing Area [mm²]” of the column “Cutting Test” of Table 3. It should be noted that a larger processing area means more excellent detachment resistance.

### <Cutting Conditions>

Workpiece: A390 (aluminum alloy)
Cutting speed Vc: 500 m/min
Feed per cutting edge: 0.2 mm/rev
Cut amount: 0.5 mm
Cutting liquid: water-soluble coolant

The coated cemented carbides according to samples 1 to 20 correspond to examples of the present disclosure. The coated cemented carbide according to sample 101 corresponds to a comparative example. In view of the results of Table 3, it was found that each of the coated cemented carbides according to samples 1 to 20 had more excellent detachment resistance than that of the coated cemented carbide according to sample 101.

In view of the above, it was found that each of the coated cemented carbides according to samples 1 to 20 had excellent detachment resistance.

Although the embodiments and examples of the present disclosure have been described as described above, it is also initially expected to appropriately combine or variously modify the configurations of the above-described embodiments and examples.

The embodiments and examples disclosed herein are illustrative and non-restrictive in any respect. The scope of the present invention is defined by the terms of the claims, rather than the embodiments and examples described above, and is intended to include any modifications within the scope and meaning equivalent to the terms of the claims.

### REFERENCE SIGNS LIST

1 substrate; 2 diamond layer; 3 coated cemented carbide; R1 inner region; R2 outer region; L1 straight line; L2 parallel line; W1 width; 10 tool; 1a rake face; 1b flank face; 1c cutting edge face

1. A coated cemented carbide comprising: a substrate consisting of a cemented carbide; and a diamond layer disposed directly on at least a portion of the substrate, wherein
the cemented carbide includes a tungsten carbide grain and cobalt,
the substrate includes an outer region and an inner region, the outer region having a gradient composition in which a content ratio of the cobalt is increased from an interface between the substrate and the diamond layer toward an inner portion of the substrate, the inner region being located on the inner portion side of the substrate with respect to the outer region,
the content ratio of the cobalt in the inner region is 2 mass % or more,
a percentage (T₂/T₁)×100 of a standard deviation T₂ μm of a thickness of the outer region with respect to an average thickness T₁ μm of the outer region is 30% or less, and
the average thickness T₁ of the outer region is 1 μm or more and 5 μm or less.

2. (canceled)

3. The coated cemented carbide according to claim 1, wherein an average thickness of the diamond layer is 3 μm or more and 28 μm or less.

4. The coated cemented carbide according to claim 1, wherein
in a cross section of the coated cemented carbide along a normal direction of a surface of the diamond layer, the substrate is provided with a recess having a depth of 1 μm or more at the interface between the substrate and the diamond layer, and
an average of a width of the recess at a depth position of 1 μm of the recess is 1 μm or more and 3 μm or less.

5. The coated cemented carbide according to claim 4, wherein the number of first recesses, each of which is the recess having the width of more than 10 μm at the depth position of 1 μm of the recess, is 1 or less in a rectangular visual field provided in the cross section and including the interface between the substrate and the diamond layer, the rectangular visual field having a length of 80 μm along the normal direction of the surface of the diamond layer and a length of 110 μm in a direction along the surface of the diamond layer.

6. The coated cemented carbide according to claim 1, wherein a content ratio of the tungsten carbide grain in the cemented carbide is 90 mass % or more and 98 mass % or less.

7. The coated cemented carbide according to claim 1, wherein the content ratio of the cobalt in the cemented carbide is 2 mass % or more and 10 mass % or less.

8. A tool consisting of the coated cemented carbide according to claim 1.
